(19) United States
(12) Patent Application Publication
(10) Pub. No.: US 2013/0144672 A1
(43) Pub. Date: Jun. 6, 2013

(54) Analytics-Based Community Value Meetings

(71) Applicants: Al Chakra, Apex, NC (US); Li Chen, Cary, NC (US); Edward C. Flickinger, Cary, NC (US); Lin Sun, Morrisville, NC (US)

(72) Inventors: Al Chakra, Apex, NC (US); Li Chen, Cary, NC (US); Edward C. Flickinger, Cary, NC (US); Lin Sun, Morrisville, NC (US)

(73) Assignee: INTERNATIONAL BUSINESS MACHINES CORPORATION, Armonk, NY (US)

(21) Appl. No.: 13/311,333

(22) Filed: Dec. 5, 2011

(51) Int. Cl. G06Q 10/10

(52) U.S. Cl. 705/7.16; 705/7.13

(57) ABSTRACT

Methods and systems of managing meetings may involve scheduling a meeting, and monitoring one or more invitee communications prior to the meeting. In addition, a prioritization may be conducted of one or more attributes of the meeting based on the one or more invitee communications.

### BACKGROUND

Embodiments of the present invention generally relate to meeting management. More particularly, embodiments relate to the use of community communications and decisions to increase the productivity of meetings.

When recurring meetings are scheduled, each meeting instance may often serve as a mere placeholder with no agenda at the time the series of recurring meetings is scheduled. Moreover, because the agenda might not yet be formulated for a particular meeting instance, it is not uncommon for the invitee list to include individuals who need not be present for the meeting instance, and exclude individuals who should be present for the meeting instance. Indeed, the lack of a specific agenda can make it difficult for invitees to determine whether to accept and/or attend the meetings, particularly if the meeting instance is not in the near future.

### BRIEF SUMMARY

Embodiments may include a computer program product having a computer readable storage medium and computer usable code stored on the computer readable storage medium. If executed by a processor, the computer usable code may cause a computer to schedule a meeting, and monitor one or more invitee communications prior to the meeting. The computer usable code can also cause a computer to conduct a prioritization of one or more attributes of the meeting based on the one or more invitee communications.

Embodiments may also include a computer program product having a computer readable storage medium and computer usable code stored on the computer readable storage medium. If executed by a processor, the computer usable code may cause a computer to schedule a recurring meeting instance, and monitor one or more invitee communications between two or more invitees of the meeting instance prior to the meeting instance. The invitee communications may include at least one of email communications, instant messaging (IM) communications, social network electronic communications, and telephonic communications. The computer usable code can also cause a computer to compare content of the one or more invitee communications to a dynamic content tool, and conduct a prioritization of one or more attributes of the meeting instance based on the invitee communications and the dynamic content tool. In addition, the computer usable code may cause a computer to transmit a meeting update to invitees of the meeting instance based on the prioritization, collect one or more invitee votes from the invitees with respect to the meeting update, and repeat the prioritization of one or more attributes of the meeting instance based on the invitee votes. Moreover, the computer usable code may cause a computer to determine whether to reschedule the meeting instance based on the invitee votes.

Other embodiments can include a computer implemented method in which a recurring meeting instance is scheduled, wherein one or more invitee communications may be monitored between two or more invitees of the meeting instance prior to the meeting instance. The invitee communications may include at least one of email communications, IM communications, social network electronic communications, and telephonic communications. The method may provide for comparing content of the invitee communications to a dynamic content tool, and conducting a prioritization of one or more attributes of the meeting instance based on the invitee communications and the dynamic content tool. In addition, a meeting update can be transmitted to invitees of the meeting based on the prioritization, wherein one or more invitee votes may be collected from the invitees with respect to the meeting update. The method may also provide for repeating the prioritization of one or more attributes of the meeting instance based on the invitee votes. In one example, a determination is made as to whether to reschedule the meeting instance based on the invitee votes.

### BRIEF DESCRIPTION OF THE SEVERAL VIEWS OF THE DRAWINGS

The various advantages of the embodiments of the present invention will become apparent to one skilled in the art by reading the following specification and appended claims, and by referencing the following drawings, in which:

FIG. 1 is a block diagram of an example of a meeting prioritization system according to an embodiment;

FIG. 2 is a flowchart of an example of a method of managing meetings according to an embodiment;

FIGS. 3A and 3B are screen shots of examples of automatically prioritized meeting notices according to an embodiment; and

FIG. 4 is a block diagram of an example of a computing architecture according to an embodiment.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

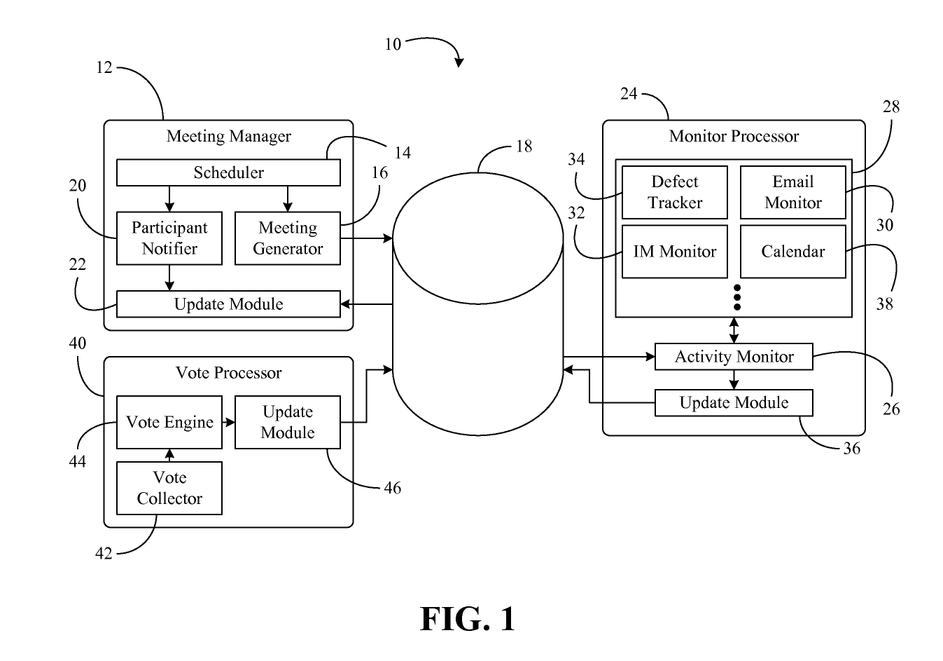

Referring now to FIG. 1, a meeting prioritization system 10 is shown. In general, the illustrated system 10 increases the productivity of meetings by using the communications and decisions of invitees and others (e.g., the “community”) to prioritize meeting attributes such as agenda items and invitees. For example, a meeting manager 12 may include a scheduler 14 that schedules recurring and non-recurring meetings, wherein recurring meetings can have multiple instances that extend into the future. A meeting generator 16 may add the scheduled meetings to a storage module such as a database 18, wherein a participant notifier 20 can be used to notify invitees of the scheduled meetings. The illustrated meeting manager 12 also includes an update module 22 that may be configured to send updates/confirmations to invitees as updates from the other components of the system 10 take place. As will be discussed in greater detail, these updates might involve the re-prioritization (e.g., importance modification) of agenda items, the addition or deletion of agenda items, the addition or deletion of invitees, and so forth.

In particular, the system 10 may have a monitor processor 24 with an activity monitor 26 that monitors various community channels 28 for content that may be useful in the meeting prioritization process. For example, the illustrated channels 28 include an email component 30 that tracks invitee communications implemented via email. Thus, the email component 30 could provide access to emails between invitees, emails from invitees to non-invitees, emails from non-invitees to invitees, and so forth. Similarly, the community channels 28 may include an instant messaging (IM) component 32 that tracks invitee communications implemented by chat messages between, to, or from invitees. Other invitee communications such as telephonic (e.g., voice mail) or short messaging service (SMS) messages may also be tracked as community channels 28 useful to the message prioritization process.

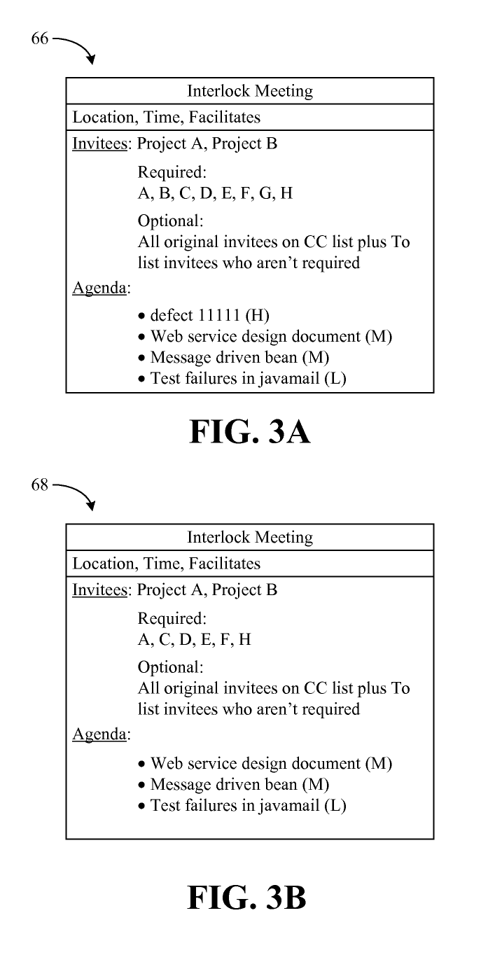

FIG. 3A shows an automatically prioritized meeting notice 66 demonstrating that invitee communications may be used to add, delete and modify the importance of various meeting attributes. In the example shown, there has been a review sent out for a web service design document with a review end date that is close to a meeting date between invitees C, D and E, so the agenda item “Web service design document” has been automatically added to the agenda with a medium priority. Similarly, if a technical topic regarding a message driven bean has been circulated and discussed back and forth in emails between invitees A, D, F and G, the agenda item “Message driven bean” could also be automatically added to the agenda with a medium priority. Moreover, if invitees D, G, and H participate in a group chat the day before the meeting, in which test failures in javamail are discussed, the agenda item “Test failures in javamail” may be added to the agenda with a low priority. Simply put, various attributes of the meeting notice 66 may be generated and/or prioritized based on invitee communications.

Returning now to FIG. 1, the illustrated community channels 28 also include a dynamic content application/tool such as, for example, a defect (e.g., bug) component 34 that tracks product and/or service defects relevant to an organization associated with the prioritization system 10, wherein the defect component 34 could enable the content of the invitee communications to be compared to a defect list or other dynamically generated/updated content. For example, the meeting notice 66 (FIG. 3) demonstrates that if there is an urgent email related to “defect 11111” between invitees A, B and C, the email component 30 may facilitate access to the content of the email, while the defect component 34 may enable a comparison of the email to the defect list. Thus, the activity monitor 26 may identify defect 11111 as an urgent item, and instruct an update module 36 to add it as a high priority agenda item to a previously scheduled meeting between invitees A, B and C. Other dynamic content tools may also be used to enhance the meeting management process.

The community channels 28 may also include a calendar component 38 that can track calendar information for an organization, wherein the calendar information might provide insight as to whether agenda items should be added to a particular meeting. For example, in the scenario provided above, if it is determined that A, B and C already have a meeting scheduled to discuss defect 11111, the activity monitor 26 may decide to forego the addition of it as an agenda item to the meeting notice 66 (FIG. 3A).

The prioritization system 10 may also include a vote processor 40 having a vote collector 42 configured to collect invitee votes as to meeting updates that might be distributed via the aforementioned update module 22. For example, invitees could be given the opportunity to vote on the priority of meeting agenda items, the importance of certain invitees, etc. The illustrated vote processor 40 also includes a vote engine 44 configured to tally the invitee votes and determine whether to instruct an update module 46 to modify meetings based on the replies received.

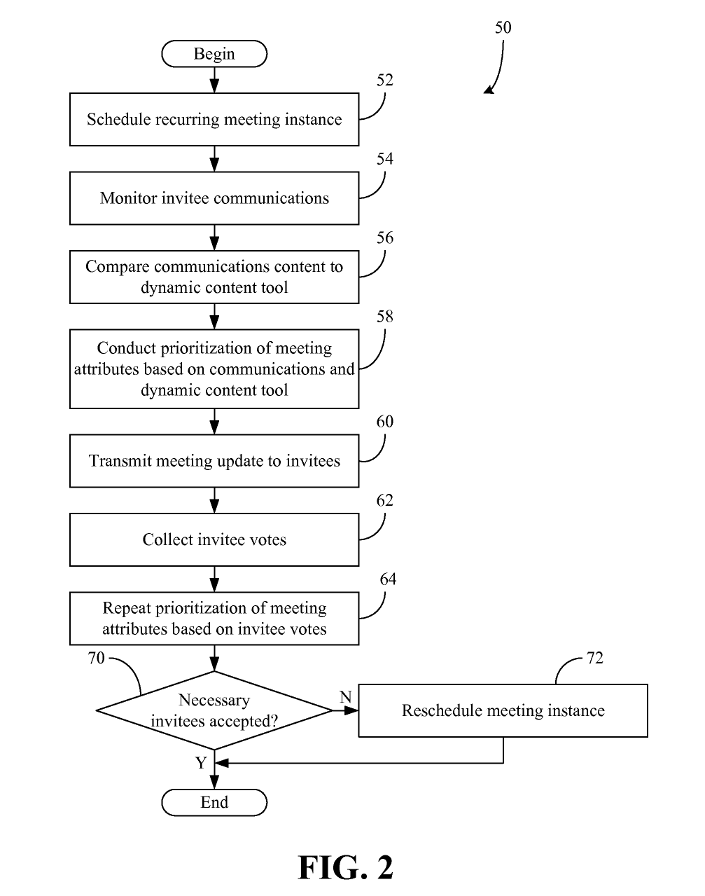

FIG. 2 shows a method 50 of managing meetings. The method 50 could be implemented in a messaging (e.g., email, chat, text, voicemail) and/or calendaring tool running on a server, client device, other computing platform, or any combination thereof. In one example, the method 50 is implemented as a prioritization system such as the system 10 (FIG. 1), already discussed. Illustrated processing block 52 provides for scheduling a recurring meeting instance, wherein one or more invitee communications may be monitored at block 54. The monitored communications could be between two or more invitees, or between an invitee and a non-invitee, and may take the form of email communications, IM communications, telephonic communications, etc. Block 56 may compare the content of the invitee communications to a dynamic content tool such as a defect list, wherein illustrated block 58 conducts a prioritization of one or more meeting attributes based on the invitee communications and/or the dynamic content tool.

For example, the prioritization could involve adding an agenda item or an invitee to the meeting. The prioritization might also involve deleting an agenda item or an invitee from the meeting. Moreover, the prioritization may involve modifying the importance of an agenda item (e.g., high, medium, low) or the importance of an attendee (e.g., required, optional). Indeed, other meeting attributes such as the meeting duration may be modified based on the invitee communications and/or the dynamic content tool, in the example shown.

Processing block 60 can provide for transmitting a meeting update to the invitees based on the prioritization results, wherein one or more invitee votes may be collected at block 62. The attribute prioritization process can also be repeated at block 64 based on the invitee votes. Thus, block 64 may provide for using the invitee votes to add, remove or prioritize agenda topics, add, remove or prioritize invitees (e.g., define as required or optional), and so forth.

For example, FIG. 3B demonstrates an updated meeting notice 68 in which invitee A has voted (e.g., using a calendar user interface enhancement) that only invitees D and F are required for the message driven bean discussion. As a result, invitee G has been automatically modified from being a required attendee to being an optional attendee, in the example shown. In addition, Invitee B has marked defect 11111 off of the agenda (perhaps because the defect has been resolved). Invitee B′s vote has therefore caused the defect 11111 agenda item to be removed, as well as invitee B′s importance to be modified to optional rather than required.

Returning now to FIG. 2, a determination may be made at block 70 as to whether all required invitees have accepted the meeting invitation. If not, the meeting, as scheduled, may not be productive and illustrated block 72 attempts to reschedule the meeting instance. Additionally, the meeting instance might be canceled if it lacks a specific agenda.

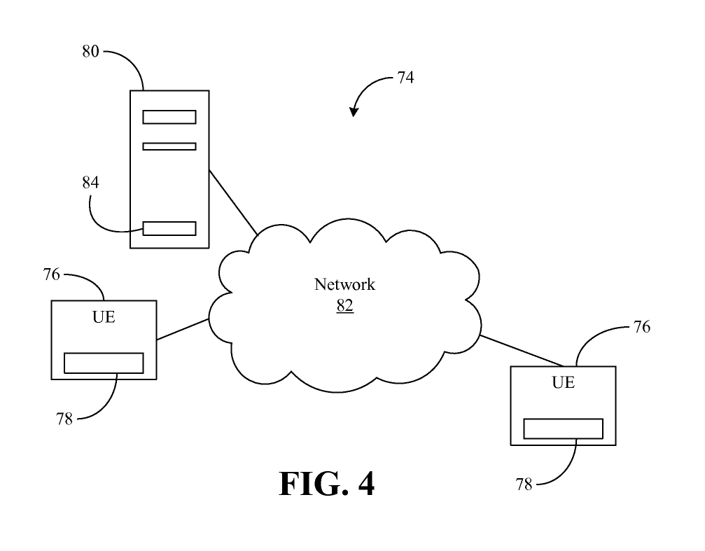

FIG. 4 shows a computing architecture 74 in which user equipment (UE) devices 76 include a calendar application 78 that enables the scheduling of meetings between users of the UE devices 76 via a network 82. The UE devices 76 may also have the ability to communicate with one another via email, instant messaging, telephone, video messaging, and so forth, via the network 82. The network 82 can itself include any suitable combination of servers, access points, routers, base stations, mobile switching centers, public switching telephone network (PSTN) components, etc., to facilitate communication between the UE devices 76 and a server 80.

In one example, the server 80 includes a meeting prioritization system 84 such as the prioritization system 10 (FIG. 1), already discussed. Accordingly, the prioritization system could be configured to schedule meetings, monitor invitee communications prior to the meetings, and conduct prioritizations of attributes of the meetings based on the invitee communications. In one example, the attributes include agenda items, invitees, meeting durations, and so forth.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

We claim:

1. A computer program product comprising:
a computer readable storage medium; and
computer usable code stored on the computer readable storage medium, where, if executed by a processor, the computer usable code causes a computer to:
schedule a recurring meeting instance;
monitor one or more invitee communications between two or more invitees of the meeting instance prior to the meeting instance, wherein the one or more invitee communications are to include at least one of email communications, instant messaging communications, social network electronic communications, and telephonic communications;
compare content of the one or more invitee communications to a dynamic content tool;
conduct a prioritization of one or more attributes of the meeting instance based on the one or more invitee communications and the dynamic content tool;
transmit a meeting update to invitees of the meeting instance based on the prioritization;
collect one or more invitee votes with respect to the meeting update;
repeat the prioritization of one or more attributes of the meeting instance based on the one or more invitee votes; and
determine whether to reschedule the meeting instance based on the one or more invitee votes.

2. The computer program product of claim 1, wherein the computer usable code, if executed, causes a computer to modify at least one of an importance of an agenda item and an importance of an invitee of the meeting based on at least one of the one or more invitee communications, the dynamic content tool, and the one or more invitee votes.

3. The computer program product of claim 1, wherein the computer usable code, if executed, causes a computer to delete at least one of an agenda item and an invitee from the meeting instance based on at least one of the one or more invitee communications, the dynamic content tool, and the one or more invitee votes.

4. The computer program product of claim 1, wherein the computer usable code, if executed, causes a computer to add at least one of an agenda item and an invitee to the meeting instance based on at least one of the one or more invitee communications, the dynamic content tool, and the one or more invitee votes.

5. The computer program product of claim 1, wherein the computer usable code, if executed, causes a computer to modify a duration of the meeting instance based on at least one of the one or more invitee communications, the dynamic content tool, and the one or more invitee votes.

6. A computer implemented method comprising:
scheduling a recurring meeting instance;
monitoring one or more invitee communications between two or more invitees of the meeting instance prior to the meeting instance, wherein the one or more invitee communications include at least one of email communications, instant messaging communications, social network electronic communications, and telephonic communications;
comparing content of the one or more invitee communications to a dynamic content tool;
conducting a prioritization of one or more attributes of the meeting instance based on the one or more invitee communications and the dynamic content tool;
transmitting a meeting update to invitees of the meeting instance based on the prioritization;
collecting one or more invitee votes with respect to the meeting update;
repeating the prioritization of one or more attributes of the meeting instance based on the one or more invitee votes; and
determining whether to reschedule the meeting instance based on the one or more invitee votes.

7. The method of claim 6, wherein the prioritization includes modifying at least one of an importance of an agenda item and an importance of an invitee of the meeting based on at least one of the one or more invitee communications, the dynamic content tool, and the one or more invitee votes.

8. The method of claim 6, wherein the prioritization includes deleting at least one of an agenda item and an invitee from the meeting instance based on at least one of the one or more invitee communications, the dynamic content tool, and the one or more invitee votes.

9. The method of claim 6, wherein the prioritization includes adding at least one of an agenda item and an invitee to the meeting instance based on at least one of the one or more invitee communications, the dynamic content tool, and the one or more invitee votes.

10. The method of claim 6, wherein the prioritization includes modifying a duration of the meeting instance based on at least one of the one or more invitee communications, the dynamic content tool, and the one or more invitee votes.

11. A computer program product comprising:
a computer readable storage medium; and
computer usable code stored on the computer readable storage medium, where, if executed by a processor, the computer usable code causes a computer to:
schedule a meeting;
monitor one or more invitee communications prior to the meeting; and
conduct a prioritization of one or more attributes of the meeting based on the one or more invitee communications.

12. The computer program product of claim 11, wherein the computer usable code, if executed, causes a computer to modify at least one of an importance of an agenda item and an importance of an invitee of the meeting based on the one or more invitee communications.

13. The computer program product of claim 11, wherein the computer usable code, if executed, causes a computer to delete at least one of an agenda item and an invitee from the meeting based on the one or more invitee communications.

14. The computer program product of claim 11, wherein the computer usable code, if executed, causes a computer to add at least one of an agenda item and an invitee to the meeting based on the one or more invitee communications.

15. The computer program product of claim 11, wherein the computer usable code, if executed, causes a computer to modify a duration of the meeting based on the one or more invitee communications.

16. The computer program product of claim 11, wherein the computer usable code, if executed, causes a computer to compare content of the one or more invitee communications to a dynamic content tool, wherein the prioritization is to be conducted further based on the dynamic content tool.

17. The computer program product of claim 11, wherein the computer usable code, if executed, causes a computer to:
transmit a meeting update to the invitees of the meeting based on the prioritization;
collect one or more invitee votes from the invitees with respect to the meeting update; and
repeat the prioritization of one or more attributes of the meeting based on the one or more invitee votes.

18. The computer program product of claim 17, wherein the computer usable code, if executed, causes a computer to determine whether to reschedule the meeting based on the one or more invitee votes.

19. The computer program product of claim 11, wherein the one or more invitee communications are to be between two or more invitees of the meeting, and are to include at least one of email communications, instant messaging communications, social network electronic communications, and telephonic communications.

20. The computer program product of claim 11, wherein the meeting is to be a recurring meeting instance.
